(19) United States
(12) Patent Application Publication
(10) Pub. No.: US 2015/0191567 A1
(43) Pub. Date: Jul. 9, 2015

(54) TETRAHYDROFURAN PURGE TREATMENT PROCESS

(71) Applicant: INVISTA NORTH AMERICA S.A.R.L., Wilmington, DE (US)

(72) Inventor: George Malcom Williamson, Wilmington, NC (US)

(73) Assignee: INVISTA NORTH AMERICA S.A.R.L., Wilmington, DE (US)

(21) Appl. No.: 14/407,492

(22) PCT Filed: Jun. 4, 2013
(86) PCT No.: PCT/US13/44033

§ 371 Date: Dec. 12, 2014

Related U.S. Application Data
(60) Provisional application No. 61/667,173, filed on Jul. 2, 2012.

(51) Int. Cl. C08G 65/30; B01D 3/36; C08G 65/20

(52) U.S. Cl. CPC C08G 65/30; C08G 65/20; B01D 3/36

(57) ABSTRACT

The present invention provides a tetrahydrofuran purge stream treatment process, and a process for manufacturing polyether glycol comprising same. The process for treating a tetrahydrofuran stream purged from a polyether glycol manufacturing process comprises steps of neutralizing acidic substances in a tetrahydrofuran stream purged from the polyether glycol manufacturing process with an aqueous base solution, feeding the neutralized effluent to an azeotropic distillation column, and distilling tetrahydrofuran and water overhead from the azeotropic distillation column. The process can further comprise a step of disposing of the neutralized salts and excess base in the aqueous bottoms stream from the azeotropic distillation column. The process can further comprise steps of recovering THF from the overhead of the azeotropic distillation column, and recycling the recovered THF to a polyether glycol manufacturing process.

### CROSS-REFERENCE TO RELATED APPLICATION

This application claims benefit of priority from U.S. Provisional Application No. 61/667,173 filed Jul. 2, 2012. This application hereby incorporates by reference this provisional application in its entirety.

### FIELD OF THE INVENTION

The present invention relates to a tetrahydrofuran purge stream treatment process, and a process for manufacturing polyether glycol comprising the tetrahydrofuran purge treatment process.

### BACKGROUND OF THE INVENTION

Homopolymers of tetrahydrofuran (THF), also known as polytetramethylene ether glycols (PTMEG), are well known for use as soft segments in polyurethanes and other elastomers. These homopolymers impart superior dynamic properties to polyurethane elastomers and fibers.

THF homopolymer preparation is disclosed, for example, by Heinsohn et al. in U.S. Pat. No. 4,163,115 and Pruckmayr in U.S. Pat. No. 4,120,903. Such homopolymer may be prepared by any of the known methods of cyclic ether polymerization, described for instance in “Polytetrahydrofuran” by P. Dreyfuss (Gordon & Breach, N.Y. 1982). Such polymerization methods include catalysis by strong proton or Lewis acids, by heteropoly acids, as well as by perfluorosulfonic acids or acid resins. In some instances it may be advantageous to use a polymerization promoter, such as a carboxylic acid anhydride, as disclosed in U.S. Pat. No. 4,163,115. In these cases the primary polymer products are diesters, which need to be hydrolyzed in a subsequent step to obtain the desired polyether glycols.

In the polymerization of THF, THF is purged from the system in order to control acidic substance, such as carboxylic acid and carboxylic acid anhydride, at desired concentration, and unreacted THF is separated from the polymer. Normally, the purged THF will be disposed of as waste, resulting in at least 1 to 5% THF yield loss. This leads to overall reduction of commercial effectiveness of the polymerization process, and increases costs.

### SUMMARY OF THE INVENTION

The present invention provides a process for treating a tetrahydrofuran stream purged from a polyether glycol manufacturing process such as a THF polymerization process. The process comprises steps of a) neutralizing acidic substances in a THF stream purged from a polyether glycol manufacturing process with an aqueous base solution in an appropriate vessel, hereinafter more particularly described, under controlled conditions, hereinafter more particularly described, b) feeding effluent from the vessel to an azeotropic distillation column, hereinafter more particularly described, and c) distilling THF and water overhead from the azeotropic distillation column. The process can further comprise a step of disposing of the neutralized salts and excess base in the aqueous bottoms stream from the azeotropic distillation column. The process can further comprise steps of recovering THF from the overhead of the azeotropic distillation column, and recycling the recovered THF to a polyether glycol manufacturing process such as a THF polymerization process.

The present invention also provides a process for manufacturing polyether glycol comprising the process for treating a tetrahydrofuran stream purged from a polyether glycol manufacturing process.

### BRIEF DESCRIPTION OF THE DRAWING

FIG. 1 is a schematic representation of one embodiment of the process for manufacturing polyether glycol comprising the tetrahydrofuran purge stream treatment process according to the present invention.

### DETAILED DESCRIPTION OF THE INVENTION

As a result of intense research in view of the above, a highly effective, commercially advantageous tetrahydrofuran purge steam treatment process is provided.

The term “polymerization”, as used herein, unless otherwise indicated, includes the term “copolymerization” within its meaning.

The term “PTMEG”, as used herein, unless otherwise indicated, means polytetramethylene ether glycol. PTMEG is also known as polyoxybutylene glycol.

The term “PTMEA”, as used herein, unless otherwise indicated, means diester such as diacetate ester of polytetramethylene ether.

The term “THF”, as used herein, unless otherwise indicated, means tetrahydrofuran and includes within its meaning alkyl substituted tetrahydrofuran capable of copolymerizing with THF, for example 2-methyltetrahydrofuran, 3-methyltetrahydrofuran, and 3-ethyltetrahydrofuran.

The term “acidic substance”, as used herein, unless otherwise indicated, includes any substance having acidity. Examples of the acidic substances are, e.g. carboxylic acids, carboxylic acid anhydrides, etc., present in the THF polymerization system. The carboxylic acid can be, e.g. aliphatic carboxylic acid, cycloaliphatic carboxylic acid, aromatic carboxylic acid, or araliphatic carboxylic acid. The carboxylic acid anhydride can be, e.g. aliphatic carboxylic acid anhydride, cycloaliphatic carboxylic acid anhydride, aromatic carboxylic acid anhydride, or araliphatic carboxylic acid anhydride. Such substances can be catalysts, promoters or molecular weight control agents used in the polymerization, or products derived therefrom.

In one embodiment, the present invention provides a process for recovering THF purged from a polyether glycol manufacturing process, comprising steps of a) neutralizing acidic substances in the THF stream purged from a THF polymerization process with an aqueous base solution in a vessel designed for this under controlled conditions, b) feeding effluent from the vessel to an azeotropic distillation column, c) distilling THF and water overhead from the azeotropic distillation column, and e) recovering THF from the overhead of the azeotropic distillation column.

In another embodiment, the present invention provides that process further comprising a step of disposing of the neutralized salts and excess base in the aqueous bottoms stream from the azeotropic distillation column.

The THF purge stream treatment process of the present invention can be used in any THF polymerization procedure, including, without any limitation, homopolymerization of THF or alkyl substituted tetrahydrofuran capable of copolymerizing with THF or copolymerization of THF or alkyl substituted tetrahydrofuran with at least one other cyclic ether, for example alkylene oxide.

A stream comprising THF is purged from the THF polymerization process, such as a PTMEG process, to control the amount of acidic substances in that process, such as acetic acid or acetic acid anhydride, at a desired concentration. Smaller amounts of THF are purged to help control color of the polymer product, such as PTMEG, and to purge water when new catalyst is added.

The purge of a THF stream from the polymerization process can be performed by any known means in the art, including, without any limitation, a purge of vapor removed from the polymer stream, a purge of liquid condensed from a vapor stream removed from the polymer or the filtrate if polymer is removed by filtration or absorption.

The purged THF stream contains small amounts of acidic substances and oligomers from the polymerization. In one embodiment, the acidic substances are present in amounts of 0 to 10 wt %, for example 0.01 to 8 wt %, such as 0.1 to 5 wt %, based on the total weight of the THF purge stream. In one embodiment, oligomers from the polymerization are present in amounts of 0 to 10 wt %, for example 0.01 to 8 wt %, such as 0.1 to 5 wt %, based on the total weight of the THF purge stream.

According to one embodiment, the acidic substance is carboxylic acid, for example an aliphatic carboxylic acid, such as acetic acid. According to another embodiment, the acidic substance is carboxylic acid anhydride, for example an aliphatic carboxylic acid anhydride, such as acetic acid anhydride.

According to one embodiment, the purge stream comprises oligomers of PTMEA.

In a specific embodiment, the purge stream comprises THF with 3 to 5 wt % of acetic acid, 0 to 1.5 wt % acetic acid anhydride, and 0 to 2 wt % of oligomers of PTMEA.

According to one embodiment, the present invention provides a process for recycling THF purged from a THF polymerization procedure, comprising steps of a) neutralizing acidic substances in a THF stream purged from a THF polymerization process with an aqueous base solution in a vessel designed for this under controlled conditions, b) feeding effluent from the vessel to an azeotropic distillation column, c) distilling THF and water overhead from the azeotropic distillation column, d) recovering the THF, and e) recycling the recovered THF to the THF polymerization process.

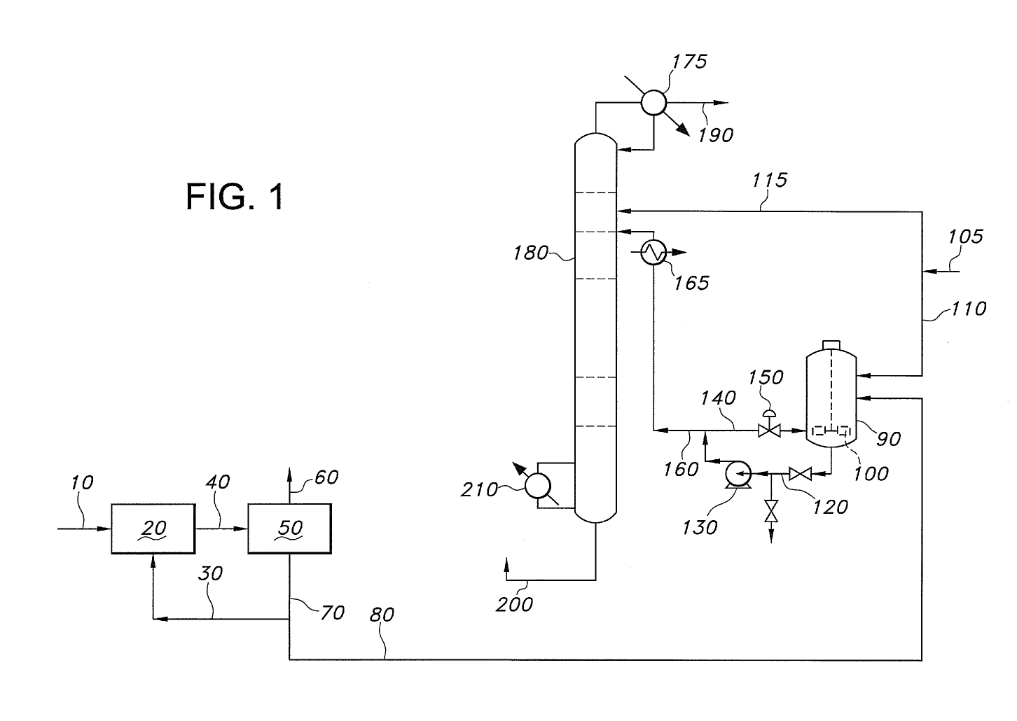

A schematic representation of an embodiment of the process according to the present invention is shown in FIG. 1.

Referring now to FIG. 1, THF feed stream 10 flows to polymerization reactor 20 along with recycle stream 30. Reactor effluent stream 40 enriched in PTMEA flows to THF/polymer separator 50 with polymer stream 60 withdrawn for further processing and THF stream 70 split between THF purge stream 80 and recycle stream 30.

THF purge stream 80 flows to neutralization tank 90 which can optionally be equipped with a mechanical stirrer 100. A first portion of the aqueous base solution stream 105 is added to neutralization tank 100 via stream 110. Aqueous base solution 105 is suitably, for example, 25% by weight of NaOH in water.

A second portion of the aqueous base solution stream 105 flows to an upper section of THF azeotropic distillation column 180 via stream 115 at a flow rate sufficient to suppress methanol formation. The flow rate may be determined by routine trial and error by measuring the methanol concentration in the THF-water azeotrope stream 190.

The neutralization in neutralization tank 90 is allowed to continue under agitation for residence time sufficient to neutralize substantially all of the acidic components in the THF purge stream 80, for example from 0.1 to 144 hours, preferably from 24 to 120 hours.

The neutralized THF purge stream 120 is withdrawn from neutralization tank 90 and charged to the suction of pump 130. Neutralization tank 90 can optionally be equipped with a pump around circuit including return line 140 and control valve 150. Pump 130 and return line 140 can optionally be sized to provide sufficient agitation for effective neutralization in the absence of a mechanical stirrer 100.

The operating temperature and pressure in the neutralization tank 90 are not particularly critical for the residence time indicated. The neutralization can be carried out at from 0 to 50° C., such as from 10 to 40° C., e.g. from 20 to 30° C., and conveniently at ambient temperature. The pressure employed is generally not critical to the result of the neutralization, and pressures such as atmospheric pressure, the autogenous pressure of the neutralization system, and elevated pressures may be used.

Examples of suitable bases for use in the aqueous base solution include hydroxides and carbonates of alkali metals and alkaline earth metals, such as sodium hydroxide, potassium hydroxide, magnesium hydroxide, sodium carbonate, potassium carbonate, magnesium carbonate, etc., as well as combinations thereof. In one embodiment, caustic is used. In one specific embodiment, sodium hydroxide is used.

An aqueous base solution in a concentration from 5 to 50 wt %, for example from 10 to 40 wt %, or from 10 to 30 wt % can be used. The concentration of the aqueous base solution can be chosen according to the amount of the acidic substances in the THF purge stream 80 so that the weight ratio of the aqueous phase and the THF phase is within a certain range.

To assure efficient neutralization of the acidic substances in the THF purge stream 80, the base is used in excess, for example, 10 to 200 mol % excess, 10 to 120 mol % excess, or 10 to 80 mol % excess, based on the molar amount of the acidic substances in the THF purge stream. In one embodiment, the base is 20 mol % in excess, and in another embodiment, the base is 50 mol % in excess, both based on the molar amount of the acidic substances in the THF purge stream 80.

The neutralized THF purge stream 160 is preheated in preheat exchanger 165 where it extracts heat from process wastewater 170 and then flows to azeotropic distillation column 180. Azeotropic distillation column 180 contains a suitable number of trays to effect separation of a THF-enriched overhead azeotrope stream 190 from wastewater bottoms stream 200. Azeotropic distillation column 180 can contain trays, packing or both. Suitable trayed columns contain 10 to 30 trays, for example 12 to 28 trays. Suitable trayed or packed columns may include a reboiler 210 to provide suitable heat input to boil at least a portion of the wastewater bottoms stream at approximately 105 to 115° C., for example 107±2° C. Similarly, suitable trayed or packed columns may include a total overhead condenser 175 with about 25% by weight of the liquid effluent refluxed to an upper tray or packed section of the tower and about 75% by weight of the liquid effluent fed forward in stream 190 to separate processing to recover THF from the THF-water azeotrope so that the THF can be recycled to the polymerization reactor 20. The azeotropic distillation column can be operated under any condition suitable for an efficient azeotropic distillation of THF/water. The column can be operated at a top temperature of 46 to 85° C., preferably 55 to 75° C., and most preferably 65 to 68° C. The pressure maintained dictates the boiling point of the azeotrope; wherein at atmospheric pressure the temperature at the top of the column head is 65 to 68° C. Lower pressures (for example 400 torr absolute) will give a lower boiling range, and higher pressures (for example 1,500 torr absolute) will give a higher boiling point for the same THF/water azeotropic composition. Useful pressures are 400 to 1,000 torr absolute.

In view of an effective azeotropic distillation of THF and water, the weight ratio of the aqueous phase and the THF phase of the stream from the neutralization vessel is from 1:1 to 1:10, preferably from 1:1.5 to 1:8, and most preferably from 1:2 to 1:5. Alternatively, additional water may be added into the neutralization vessel in order to adjust the volume ratio of the aqueous phase and the THF phase. In one embodiment, the aqueous phase is 25 to 30 wt % of the neutralized mixture and the organic phase is 70 to 75 wt % of the mixture. In another embodiment, the aqueous phase is 26 to 31 wt % of the neutralized mixture and the organic phase is 69 to 74 wt % of the mixture.

As the salt formed from the neutralization forces out an aqueous phase, rapid phase separation occurs.

When the neutralization is complete, the content of the neutralization tank is then introduced into an azeotropic distillation column, optionally passing an azotropic column preheater. In the transport of the neutralized content of the neutralization tank to the azeotropic distillation column, the content may separate into two phases, i.e. aqueous and THF phases. The two phases can be fed together or separately into the column. Preferably, the bottom of the tank is pumped off so that the aqueous phase is introduced into the column first, then the organic phase. The azeotropic distillation column bottoms pH control will be easier if the caustic addition from the aqueous phase is predictable.

Alternatively, a normal azeotropic distillation column feed can be introduced into the column together with the content from the neutralization tank.

THF and water are distilled overhead from the azeotropic distillation column, and waste water is discharged from the bottom.

The liquid effluent from the azeotropic distillation column then can be sent to a further treatment process. The THF/water azeotrope can be further treated, for example by distillation, adsorption or any conventional means in the art for removing residual water to provide THF with higher purity. The THF obtained can then be recycled into the polymerization process.

The size of the plant used for the THF purge treatment can vary. For example, the process can be scaled from benchtop to pilot plant to commercial size with substantially the same unit operations.

The PTMEA produced by the present process may be further reacted to produce polyether glycol, with the THF purge recycle process integrated into the plant operations. In one embodiment, the THF purge recycle process is practiced as a batch purge when product changes are carried out in the manufacture of polyether glycol.

The polymerization step in the process for manufacturing polyether glycol of the present invention is generally carried out at from 0 to 120° C., such as from 40 to 80° C., e.g. from 40 to 72° C. The pressure employed in the polymerization step is generally not critical to the result of the polymerization, and pressures such as atmospheric pressure, the autogenous pressure of the polymerization system, and elevated pressures may be used.

To avoid the formation of peroxides, the polymerization step of the present process may be conducted under an inert gas atmosphere. Non-limiting examples of suitable inert gases for use herein include nitrogen, carbon dioxide, or the noble gases.

The polymerization step of the present invention can also be carried out in the presence of hydrogen at hydrogen pressure of from 0.1 to 10 bar.

The process of the invention can be carried out continuously, or with one or more steps of the process being carried out batchwise.

The polymerization reaction can be carried out in conventional reactors or reactor assemblies suitable for continuous processes in a suspension or fixed-bed mode, for example, in loop reactors or stirred reactors in the case of a suspension process or in tube reactors or fixed-bed reactors in the case of a fixed-bed process. A continually stirred tank reactor (CSTR) is desirable due to the need for good mixing in the present polymerization process, especially when the products are produced in a single pass mode.

Any catalyst suitable for the manufacture of polyether glycol, specifically THF polymerization, known in the art can be used in the process of the present invention. Such catalysts include any suitable acid catalyst, for example, perfluorosulfonic acid resin, fluorosulfonic acid or perchloric acid, merely to name a few non-limiting examples.

Any promoter or molecular weight control agent suitable for the manufacture of polyether glycol, specifically THF polymerization, known in the art can also be used in the process of the present invention. Examples thereof include acetic anhydride and acetic acid.

When a continuous polymerization reactor apparatus is used, the catalyst can, if desired, be preconditioned after it has been introduced into the reactor(s). Examples of catalyst preconditioning include drying by means of gases, for example, air or nitrogen, which have been heated to 80 to 200° C. The catalyst can also be used without preconditioning.

In a fixed-bed process, the polymerization reactor apparatus can be operated in the upflow mode, that is, the reaction mixture is conveyed from the bottom upward, or in the downflow mode, that is, the reaction mixture is conveyed through the reactor from the top downward.

The polymerization reactor can be operated using a single pass without internal recirculation of product, or with recirculation such as in a CSTR. The polymerization reactor can also be operated in the circulation mode, i.e. the polymerization mixture leaving the reactor is circulated. In the circulation mode, the ratio of recycle to feed is less than 100:1, for example less than 50:1, or for example less than 40:1.

Feeds can be introduced to the polymerization reactor using delivery systems common in current engineering practice either batchwise or continuously.

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and not as restrictive.

### Materials

THF was obtained from ChemCentral. The acetic acid anhydride and acetic acid were purchased from Aldrich Chemicals. Deionized water was used. A 50% NaOH solution was purchased from J. T. Baker.

### Analytical Methods

The components of the streams are determined by gas chromatograph (GC) using a 60 meter DB-1 column with helium carrier gas. All GC results in the present application are described by retention time (RT) in minutes and area %.

The pH is determined by EMD pH paper with indicator calibrated for the range 2 to 9 pH in 0.5 pH unit increments.

### EXAMPLES

All parts and percentages are by weight unless otherwise indicated. All symbols have their usual meanings as known to those skilled in the art, e.g. HAc is acetic acid; ACAN is acetic acid anhydride; BDO is butanediol; BHT is butylated hydroxytoluene.

### Example 1

THF was polymerized over perfluorosulfonic acid resin catalyst with molecular weight control via acetic acid anhydride and acetic acid. After polymerization, the excess THF, acetic acid anhydride and acetic acid was removed as a purge stream by vaporization at 400 torr and then 20 torr. This purge stream (THF purge stream) comprised 92.8 wt % THF, 4.1 wt % acetic acid, 0.5 wt % acetic acid anhydride, and 2.6 wt % of oligomers of PTMEA. The THF purge stream was introduced into a neutralization tank and mixed with an aqueous base solution comprising 25 wt % NaOH and some additional water, and agitated with a stirrer for 24 hours at ambient temperature. The mixture was then settled into an aqueous phase and an organic phase in the neutralization tank. The aqueous phase was 27 wt % of the neutralized mixture and the organic phase was 73 wt % of the mixture. The aqueous phase was pumped off the bottom of the tank and entered the azeotropic distillation column first, and then the organic phase was introduced into the azeotropic distillation column. The component analysis of the aqueous and organic streams is presented in Table I below.

Table I

| | Stream | |
|---|---|---|
| | Aqueous | Organic |
| Component | wt % | wt % |
| THF | 10 | 92 |
| Water | 60 | 8 |
| NaAc | 24 | |
| NaOH | 3 | |
| BDO | 3 | |
| Total | 100 | 100 |
| Weight Fraction of Mixture | 0.27 | 0.73 |

### Example 2

Another experiment was conducted with the same THF polymerization procedure as in Example 1. A THF purge stream from the polymerization system was neutralized and distilled as in Example 1 under conditions as described below.

Neutralization was performed by adding 50% NaOH, using 20 molar % excess of NaOH (of that required to neutralize HAc and ACAN) in an overall solution at 22% H₂O in THF for 24 hours at ambient temperature. Rapid phase separation occurred as the acetate salts forced out an aqueous phase from the primary THF phase. Results (GC) for the THF phase are presented in Table II. GC Peaks are in area %.

TABLE II

| Compound | | | | | | | |
|---|---|---|---|---|---|---|---|
| RT (min.) | Compound | Feed | 1 hr | 2 hr | 4 hr | 6 hr | 24 hr |
| 10.219 | HAc | 1.4134 | 0.0000 | 0.0000 | 0.0000 | 0.0000 | 0.0000 |
| 10.36-10.68 | THF | 97.1683 | 98.8166 | 98.9021 | 98.9981 | 99.0560 | 99.2486 |
| 12.235 | ACAN | 0.0287 | 0.0007 | 0.0009 | 0.0009 | 0.0009 | 0.0008 |
| 13.979 | BDO | 0.2936 | 0.2720 | 0.2542 | 0.2326 | 0.2172 | 0.1904 |
| | diacetate | | | | | | |
| 16.077 | 1,4-BDO | 0.0000 | 0.0407 | 0.0724 | 0.1036 | 0.1187 | 0.1236 |
| 18.647 | diBDO | 0.7489 | 0.5223 | 0.4282 | 0.3273 | 0.2741 | 0.1579 |
| | diacetate | | | | | | |
| 21.64 | BHT | 0.0465 | 0.0514 | 0.0515 | 0.0044 | 0.0042 | 0.0493 |
| 22.775 | triBDO | 0.0781 | 0.0655 | 0.0661 | 0.0673 | 0.0637 | 0.0376 |
| | diacetate | | | | | | |

It can be seen that the amounts of HAc and ACAN are close to zero soon after NaOH addition, indicating the neutralization was effective. Contents of some compounds decreased over time (acetates or diacetates reacting to hydrolyze, which makes free BDO). Contents of some compounds increased with time (BDO and other compounds). THF got higher in purity over time.

Neutralization with the caustic solution in this example produced two phases. The top phase decanted off (5 to 6% H₂O, nominally neutral) and distilled in a 15 plate Oldershaw column. The distillation was run at atmospheric pressure with a 5:1 reflux ratio to collect the THF azeotrope. The column top temperature was 65 to 68° C. Fractions were collected and examined by GC. The distillation was halted when the head temperature started to rise above 70° C., and the resulting residue was also analyzed by GC, observing residual unreacted acetate and diacetate species.

The THF/H₂O azeotrope (5.5% H₂O) contained very low impurity levels. These higher boiling impurities accumulate in the still heel (PTMEG mono- and diacetates, 1,4-butanediol and related oligomers formed by hydrolysis of these diacetate species which stay in the heel of the pot). Results (GC) are presented in Table III. GC Peaks are in area %.

TABLE III

| Compound | | | | | | |
|---|---|---|---|---|---|---|
| RT (min.) | Compound | 24 hr. Still Feed | Fraction 1 | Fraction 2 | Fraction 5 | Pot Frac. 7 |
| 10.219 | HAc | 0.0000 | 0.0000 | 0.0000 | 0.0000 | 0.0000 |
| 10.36-10.6 | THF | 99.2153 | 99.6384 | 99.8130 | 99.9648 | 93.2461 |
| 12.235 | ACAN | 0.0008 | 0.0029 | 0.0012 | 0.0000 | 0.0000 |
| 13.979 | BDO | 0.1904 | 0.0000 | 0.0000 | 0.0000 | 1.5687 |
| | diacetate | | | | | |
| 16.077 | 1,4-BDO | 0.1236 | 0.0000 | 0.0000 | 0.0000 | 1.4864 |
| 18.647 | diBDO | 0.1579 | 0.0000 | 0.0000 | 0.0000 | 1.4839 |
| | diacetate | | | | | |
| 21.64 | BHT | 0.0493 | 0.0016 | 0.0000 | 0.0000 | 0.0026 |
| 22.775 | triBDO | 0.0376 | 0.0000 | 0.0000 | 0.0000 | 0.0315 |
| | diacetate | | | | | |

### Example 3

Another experiment was conducted with the same THF polymerization procedure as in Example 1. A THF purge stream from the polymerization system was neutralized and distilled as in Example 1 under conditions as described below.

Neutralization was performed by using 50 molar % excess NaOH in an overall solution at 15% H₂O in THF for 120 hours at ambient temperature. Results (GC) are presented in Table IV. GC Peaks are in area %.

TABLE IV

| Compound | | | | | | | | |
|---|---|---|---|---|---|---|---|---|
| RT (min.) | Compound | Feed | 10 min. | 1 hr. | 2 hr. | 6 hr. | 30 hr. | 120 hr. |
| 10.219 | HAc | 1.4134 | 0.0004 | 0.0000 | 0.0000 | 0.0000 | 0.0000 | 0.0000 |
| 10.36-10.68 | THF | 97.1683 | 98.6072 | 98.6744 | 98.8852 | 99.0586 | 99.3950 | 99.4876 |
| 12.235 | ACAN | 0.0287 | 0.0006 | 0.0010 | 0.0008 | 0.0008 | 0.0008 | 0.0008 |
| 13.979 | BDO | 0.2936 | 0.2929 | 0.2799 | 0.2433 | 0.1897 | 0.0413 | 0.0008 |
| | diacetate | | | | | | | |
| 16.077 | 1,4-BDO | 0.0000 | 0.0000 | 0.0125 | 0.0373 | 0.1141 | 0.2404 | 0.2401 |
| 18.647 | diBDO | 0.7489 | 0.7220 | 0.6596 | 0.4996 | 0.3025 | 0.0108 | 0.0003 |
| | diacetate | | | | | | | |
| 21.64 | BHT | 0.0465 | 0.0487 | 0.0478 | 0.0405 | 0.0011 | 0.0441 | 0.0433 |
| 22.775 | triBDO | 0.0781 | 0.0756 | 0.0759 | 0.0608 | 0.0593 | 0.0470 | 0.0141 |
| | diacetate | | | | | | | |

Neutralization was complete in this experiment. The composition of the neutralized pot indicated that some compounds decreased over time (acetates or diacetates reacting to hydrolyze, which makes free BDO). Compositions of some compounds increased with time (BDO and other compounds). THF got higher in purity over time. In this example, the acetates and diacetates were nearly gone at the end of 120 hours. It is noted from this example that concentrations of certain compounds decreased with time at ambient temperature.

Distillation in Example 3 was performed in a similar way as in Example 2. The pH of the overhead THF phase was 5.5 (same as DI water) and shows zero HAc in the GC. The product demonstrated that acetates reacted slowly over time. Results (GC) are presented in Table V. GC Peaks are in area %.

TABLE V

| | | pH Distillate/Heel | | | | |
|---|---|---|---|---|---|---|
| Compound | | 5.5 | 5.5 | 5.5 | 5.5 | 8.0 |
| RT (min.) | Compound | 24 hr. Still Feed | Fraction 1 | Fraction 3 | Fraction 5 | Pot Frac. 7 |
| 10.219 | HAc | 0.0000 | 0.0000 | 0.0000 | 0.0000 | 0.0000 |
| 10.36-10.6 | THF | 99.4876 | 99.781 | 99.903 | 99.866 | 94.3461 |
| 12.235 | ACAN | 0.0008 | 0.0008 | 0.0007 | 0.0002 | 0.0030 |
| 13.979 | BDO | 0.0008 | 0.0000 | 0.0000 | 0.0000 | 0.0067 |
| | diacetate | | | | | |
| 16.077 | 1,4-BDO | 0.2401 | 0.0000 | 0.0000 | 0.0000 | 3.5521 |
| 18.647 | diBDO | 0.0003 | 0.0000 | 0.0000 | 0.0000 | 0.0004 |
| | diacetate | | | | | |
| 21.64 | BHT | 0.0433 | 0.0000 | 0.0000 | 0.0000 | 0.5276 |
| 22.775 | triBDO | 0.0141 | 0.0000 | 0.0000 | 0.0000 | 0.1644 |
| | diacetate | | | | | |

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

1. A process for treating a tetrahydrofuran stream purged from a polyether glycol manufacturing process comprising steps of:
a) neutralizing acidic substances in a tetrahydrofuran stream purged from a polyether glycol manufacturing process with an aqueous base solution in a vessel under controlled conditions to obtain an effluent comprising tetrahydrofuran, water, neutralized salts and excess base,
b) feeding effluent from the vessel of step a) to an azeotropic distillation column, and
c) distilling the effluent in the azeotropic distillation column of step b) to obtain an overhead stream comprising tetrahydrofuran and water.

2. The process of claim 1 further comprising a step of disposing of neutralized salts and excess base in the aqueous bottoms stream from the azeotropic distillation column of step b).

3. The process of claim 1 wherein the controlled conditions include agitation for 0.1 to 144 hours.

4. The process of claim 1 wherein the acidic substances are selected from carboxylic acids, carboxylic acid anhydrides and combinations thereof.

5. The process of claim 1 wherein the acidic substances are selected from aliphatic carboxylic acids, aliphatic carboxylic acid anhydrides and combinations thereof.

6. The process of claim 1 wherein the acidic substances are selected from acetic acid, acetic acid anhydride and combinations thereof.

7. The process of claim 1 wherein the base in the aqueous base solution comprises hydroxides or carbonates of alkali metals or alkaline earth metals, or combinations thereof.

8. The process of claim 7 wherein the aqueous base solution comprises sodium hydroxide, potassium hydroxide, magnesium hydroxide, sodium carbonate, potassium carbonate, magnesium carbonate or combinations thereof.

9. The process of claim 1 wherein the aqueous base solution is in a concentration of from 5 to 50 wt %.

10. The process of claim 1 wherein the base in the aqueous base solution is from 10 to 200 mol % in excess, based on the molar amount of the acidic substances in the tetrahydrofuran stream purged from a polyether glycol manufacturing process.

11. The process of claim 1 wherein the azeotropic distillation column is operated at a top temperature of from 46 to 85° C.

12. The process of claim 11 wherein the azeotropic distillation column is operated at a top temperature of from 55 to 75° C.

13. The process of claim 11 wherein the azeotropic distillation column is operated at a pressure of from 400 to 1500 torr (abs).

14. A process for manufacturing polyether glycol comprising the tetrahydrofuran purge treatment process of claim 1.

15. The process of claim 14 comprising a step of polymerizing tetrahydrofuran at a temperature from about 40° C. to about 80° C.

16. The process of claim 14 comprising a step of polymerizing tetrahydrofuran in a continually stirred tank reactor.

17. A process for recycling tetrahydrofuran purged from a polyether glycol manufacturing process comprising steps of:
a) neutralizing acidic substances in a tetrahydrofuran stream purged from a polyether glycol manufacturing process with an aqueous base solution in a vessel under controlled conditions to obtain an effluent comprising tetrahydrofuran, water, neutralized salts and excess base,
b) feeding effluent from the vessel of step a) to an azeotropic distillation column,
c) distilling the effluent in the azeotropic distillation column of step b) to obtain an overhead stream comprising tetrahydrofuran and water,
d) recovering tetrahydrofuran from the overhead stream of step c), and
e) recycling the tetrahydrofuran recovered in step d) to the polyether glycol manufacturing process.

18. The process of claim 17 wherein the base in the aqueous base solution comprises hydroxides or carbonates of alkali metals or alkaline earth metals, or combinations thereof.

19. The process of claim 18 wherein the aqueous base solution comprises sodium hydroxide, potassium hydroxide, magnesium hydroxide, sodium carbonate, potassium carbonate, magnesium carbonate or combinations thereof.

20. The process of claim 17 wherein the aqueous base solution is in a concentration of from 5 to 50 wt %.
